(19) United States
(12) Patent Application Publication
(10) Pub. No.: US 2014/0180618 A1
(43) Pub. Date: Jun. 26, 2014

(54) TEST DEVICE FOR TESTING STARTUP FUNCTION OF ELECTRONIC DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventor: JIN-LIANG XIONG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/092,943

(22) Filed: Nov. 28, 2013

(30) Foreign Application Priority Data
Dec. 22, 2012 (CN) 2012105620707

(51) Int. Cl. G05B 19/418

(52) U.S. Cl. CPC G05B 19/41875
USPC 702/83

(57) ABSTRACT

A test device for testing an electronic device, includes an alternating current (AC) input port used to connect to an AC power source. An AC output port used to connect to a power port of the electronic device, a switch unit connected between the AC input port and the AC output port, a first USB port, a startup control unit, and a power on maintaining unit. The switch unit is used to establish a connection between the AC input port and the AC output port, or to cut off the connection. The first USB port connects to a second USB port of the electronic device. The startup control unit turns on the switch unit after the electronic device is turned off for a predetermined time. The power on maintaining unit maintains the switch unit to turn on after the electronic device is turned on.

### BACKGROUND

1. Technical Field

The present disclosure relates to test devices, particularly, to a test device for testing the startup of an electronic device.

2. Description of Related Art

A procedure for testing the startup function of the electronic device before the electronic device leaves the factory is necessary. The usual test method is to connect the electronic device to be tested with an alternating current (AC) power source, and install an auto-off program in the electronic device. The AC power source provides power to the electronic device and turns on the electronic device periodically. The auto-off program runs automatically when the electronic device is turned on and turns off the electronic device after a predetermined time (such as 15 seconds). Therefore, the electronic device is turned on and off repeatedly. To ensure the electronic device is turned on completely, the duration the power is provided to the electronic device from the AC power source is set to a longer time. After the electronic device is turned off, the AC power source powers the electronic device again after a certain duration to avoid powering the electronic device before the electronic device has completely turned off. However, this certain duration is time consuming. In the present test method, the AC power source provides power alternately at predetermined test times, thus, it is difficult to know whether or not the test of the electronic device fails.

A test device for testing the startup function of the electronic device to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a first embodiment of a test device for testing a startup function of an electronic device.

FIG. 2 is a circuit diagram of a second embodiment of a test device for testing a startup function of an electronic device.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

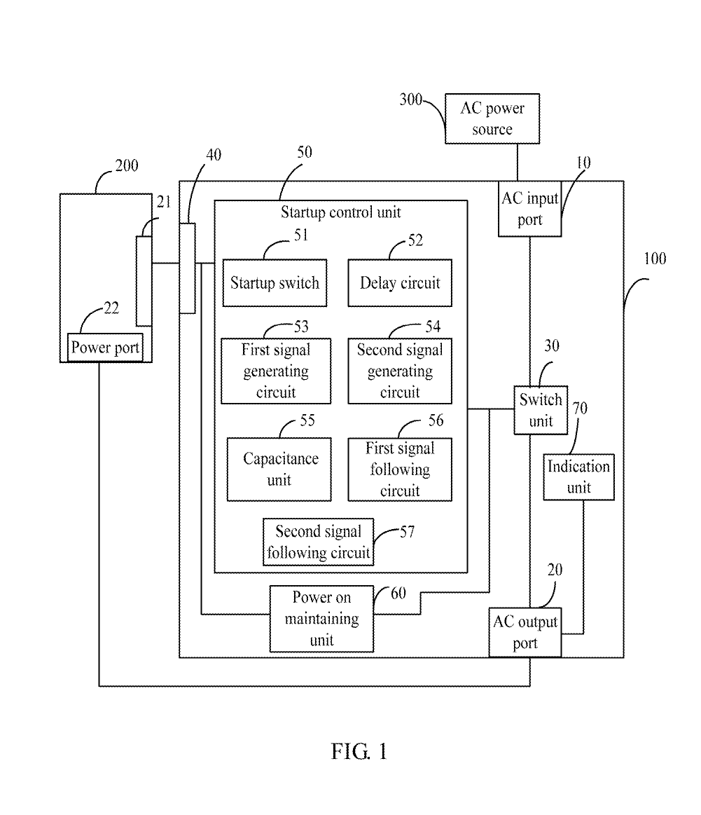

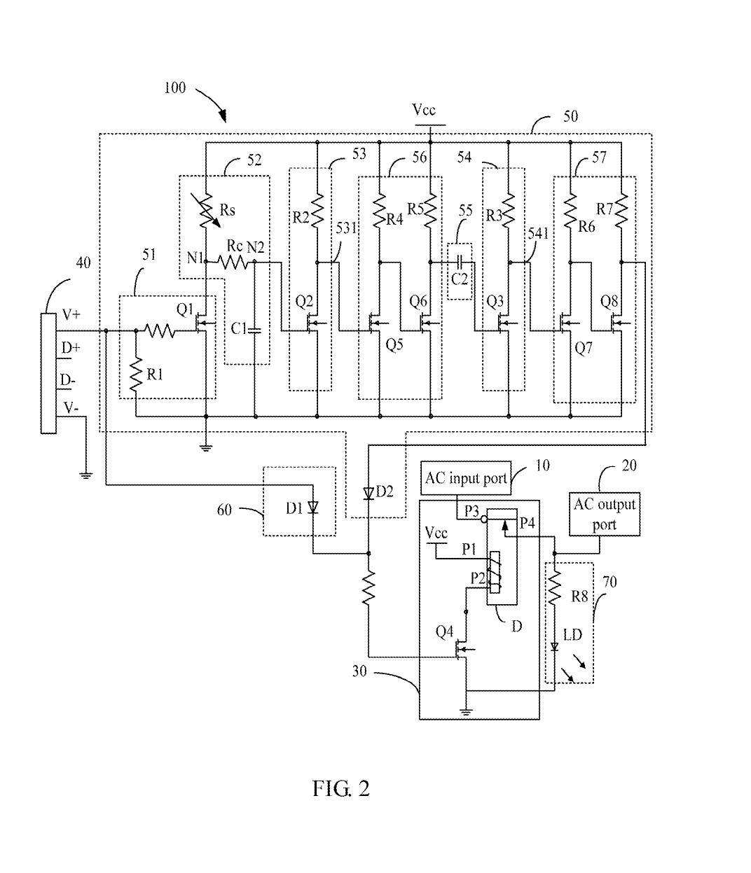

FIGS. 1 and 2 show a test device 100 for testing the startup function of an electronic device 200. The test device 100 is connected to the electronic device 200 to be tested and an alternating current (AC) power source 300. The test device 100 includes an AC input port 10, an AC output port 20, a switch unit 30, a universal serial bus (USB) port 40, a startup control unit 50, and a power on maintaining unit 60. The electronic device 200 includes a USB port 21 and a power port 22.

The AC input port 10 is connected the AC power source 300, and the AC output port 20 is connected to the power port 22 of the electronic device 200. The switch unit 30 is connected between the AC input port 10 and the AC output port 20, and is used to establish a connection between the AC input port 10 and the AC output port 20 or cut off the connection between the AC input port 10 and the AC output port 20. When the connection between the AC input port 10 and the AC output port 20 is established, the AC power source 300 provides power to the electronic device 200 via the AC output port 20. When the connection between the AC input port 10 and the AC output port 20 is cut off, the AC power source 300 stops providing the power to the electronic device 200. The USB port 40 is used to connect to the USB port 21 of the electronic device 200.

The startup control unit 50 is connected between the switch unit 30 and the USB port 40, and is used to turn on the switch unit 30 after the electronic device 200 is turned off for a predetermined time (such as 10 seconds). Thus, the AC power source 300 powers the electronic device 200. The power on maintaining unit 60 is also connected between the switch unit 30 and the USB port 40, and is used to maintain the switch unit 30 to turn on when receiving power from the USB port 40 after the electronic device 200 has been started up completely, and until the electronic device 200 is shut down by running a power-off program.

In the embodiment, the electronic device 200 installs the power-off program, the power-off program is an auto-run program and would run when the electronic device 200 is started up completely. When the power-off program is run, the power-off program would turn off the electronic device 200 after a certain time, such as 1 minute.

In the embodiment, the startup control unit 50 includes a startup switch 51, a delay circuit 52, a first signal generating circuit 53, a second signal generating circuit 54, and a capacitance unit 55. The startup switch 51, the delay circuit 52, the first signal generating circuit 53, the capacitance unit 55, and the second signal generating circuit 54 are connected between the voltage pin of the USB port 40 and the switch unit 30 in series. The startup switch 51 is connected to the voltage pin V+ of the USB port 40. When the USB port 40 of the test device 100 is connected to the USB port 21 of the electronic device 200 to be tested and the electronic device 200 has not been started up completely, the USB port 40 does not output voltage and the startup switch 51 is turned off. The delay circuit 52 starts to work when the startup switch 51 is turned off. In detail, the delay circuit 52 measures a time elapsed when the startup switch 51 is turned off and produces a trigger signal when the elapsed time reaches the predetermined time.

The first signal generating circuit 53 produces a first signal when receiving the trigger signal from the delay circuit 52. The capacitance unit 55 is connected between the first signal generating circuit 53 and the second signal generating circuit 54, and is used to transmit the first signal from the first signal generating circuit 53 to the second signal generating circuit 54. The second signal generating circuit 54 outputs an on signal to the switch unit 30 to turn on the switch unit 30 when receiving the first signal. Therefore, the connection between the AC input port 10 and the AC output port 20 is established, and the AC power source 300 provides power to the electronic device 200. Therefore, when the duration that the electronic device 200 is turned off reaches the predetermined time, the electronic device 200 would be powered on again. When the electronic device 200 is turned on, the electronic device 200 would be powered off again after a certain time by running the power-off program.

In the embodiment, the electronic device 200 is a computer, as known, when the computer is turned on completely, the USB port of the computer would output voltage. That is, the USB port 21 of the electronic device 200 would output voltage only when the electronic device 200 is turned on. The power on maintaining unit 60 receives the power from the USB port 21 when the electronic device 200 is turned on and controls the switch unit 30 to turn on. When the electronic device 200 is turned off, the USB port 21 of the electronic device 200 stops outputting the voltage, and the power on maintaining unit 60 is powered off and does not controls the switch unit 30 to turn on, namely the switch unit 30 is now turned off. Thus, the AC power source 300 stops powering the electronic device 200 after the electronic device 200 is turned off.

In the embodiment, when the electronic device 200 has been started up completely and enters the operating system, the startup switch 51 is turned on and the delay circuit 52 stops outputting the trigger signal and the second signal generating circuit 54 stops outputting the on signal to the switch unit 30. The switch unit 30 is only controlled by the power on maintaining unit 60.

In the embodiment, the startup control unit 50 also includes a first follower 56 and a second follower 57. The first follower 56 is connected between the first signal generating circuit 53 and the capacitance unit 55, and is used to transmit the first signal output by the first signal generating circuit 53 to the capacitance unit 55. The second follower 57 is connected between the second signal generating circuit 54 and the switch unit 30, and is used to transmit the on signal output by the second signal generating circuit 54 to the switch unit 30.

In the embodiment, the first follower 56 and the second follower 57 can prolong the delay time. In another embodiment, the first follower 56 and the second follower 57 can be omitted.

In the embodiment, the test device 100 also includes an indication unit 70, and the indication unit 70 is connected to the AC output port 20. When the switch unit 30 is turned on, the AC output port 20 receives the voltage from the AC input port 10 via the switch unit 30 which is turned on, and provides the voltage to the indication unit 70. The indication unit 70 produces a corresponding indication signal when receiving the voltage from the AC output port 20.

The present test device 200 can control the AC power source 300 to stop powering the electronic device 200 when the electronic device 200 is turned off, and control the AC power source 300 to provide the power to the electronic device 200 again after the electronic device 200 is turned off for the predetermined time. Thus, a total test time for testing the electronic device 200 is greatly decreased.

FIG. 2 shows a circuit diagram of the test device of the illustrated embodiment. The USB port 40 includes a voltage pin V+, data pins D+, D−, and a ground pin V−. The startup switch 51 includes an n-channel metal oxide semiconductor field effect transistor (NMOSFET) Q1 and a resistor R1. A gate of the NMOSFET Q1 is connected to the power pin V+ of the USB port 40, a source of the NMOSFET Q1 is grounded via the resistor R1, and a drain of the NMOSFET Q1 is connected to the delay circuit 52.

The delay circuit 52 includes a variable resistor Rs, a delay resistor Rc, and a delay capacitor C1. The variable resistor Rs, the delay resistor Rc, and the delay capacitor C1 are connected between a voltage port Vcc and grounded in series. A connection node N1 of the variable resistor Rs and the delay resistor Rc is connected to the drain of the NMOSFET Q1. A connection node N2 of the delay resistor Rc and the delay capacitor C1 is connected to the first signal generating circuit 53. In the embodiment, the voltage port Vcc outputs a corresponding voltage when the test device 100 is turned on.

The first signal generating circuit 53 includes a resistor R2 and a NMOSFET Q2 connected between the voltage port Vcc and ground in series. A drain of the NMOSFET Q2 is connected to the voltage port Vcc via the resistor R2, a source of the NMOSFET Q2 is grounded, and a gate of the NMOSFET Q2 is connected to the connection node N2 of the delay resistor Rc and the delay capacitor C1. The drain of the NMOSFET Q2 constitutes an output port 531 of the first signal generating circuit 53.

The second signal generating circuit 54 includes a resistor R3 and a NMOSFET Q3 connected between the voltage port Vcc and ground in series. A drain of the NMOSFET Q3 is connected to the voltage port Vcc via the resistor R3, a source of the NMOSFET Q3 is grounded, and a gate of the NMOSFET Q3 is connected to the capacitance unit 55. The drain of the NOMSFET Q3 constitutes an output port 541 of the second signal generating circuit 54.

The capacitance unit 55 includes a capacitor C2, a first terminal of the capacitor C2 is electrically connected to the drain of the NMOSFET Q2, namely the output port 531 of the first signal generating circuit 53, a second terminal of the capacitor C2 is electrically connected to the gate of the NMOSFET Q3.

The switch unit 30 includes a relay D and a NMOSFET Q4, the relay D includes a first coil terminal P1, a second coil terminal P2, a normally closed end P3, and a normally open end P4. The first coil terminal P1 is connected to the voltage port Vcc, and the second coil terminal P2 is connected to a drain of the NMOSFET Q4. The normally closed end P3 is connected to the AC input port 10, and the normally open end P4 is connected to the AC output port 20. A gate of the NMOSFET Q4 is electrically connected to the drain of the NMOSFET Q3, and a source of the NMOSFET Q4 is grounded.

The power on maintaining circuit 60 includes a diode D1. The diode D1 is forward biased between the voltage pin V+ of the USB port 40, and the gate of the NMOSFET Q4.

Therefore, when the electronic device 200 to be tested has not been started up completely, the USB port 21 of the electronic device 200 does not output the high voltage. Thus, the USB port 40 of the electronic device 200 does not receive the high voltage from the USB port 21 of the electronic device 200, and the NMOSFET Q1 is turned off because the gate of the NOMOSFET Q1 does not receive the high voltage. The delay circuit 52 begins charging the delay capacitor C1 when the NMOSFET Q1 is turned off. Namely, the variable resistor Rs and the delay resistor Rc conduct the voltage output from the voltage port Vcc to the delay capacitor C1 and charges the delay capacitor C1. During the delay capacitor C1 being charged, a voltage of the second connection node N2 of the delay resistor Rc and the delay capacitor C1 is enhanced gradually. When the voltage of the second connection node N2 is enough to turn on the NMOSFET Q2 of the first signal generating circuit 53, the output port 531 of the first signal generating circuit 53 is grounded via the NMOSFET Q2, which is turned on. Thus, the first signal generating circuit 53 outputs the first signal with the low voltage via the output port 531.

The voltage difference between two terminals of one the capacitor can not be changed suddenly. Therefore, when the first terminal of the capacitor C2 of the capacitance unit 55 receives the low voltage first signal, the second terminal of the capacitor C2 also outputs the low voltage first signal. That is, the capacitor C2 conducts the low voltage first signal from the first signal generating circuit 53 to the second signal generating circuit 54.

In the embodiment, the on signal output by the second signal generating circuit 54 is a high voltage signal. When the gate of the NMOSFET Q3 of the second signal generating circuit 54 receives the low voltage first signal, the NMOSFET Q3 is turned off accordingly. The drain of the NMOSFET Q3, namely the output port 541 of the second signal generating circuit 54 receives the high voltage from the voltage port Vcc via the resistor R3. Thus the second signal generating circuit 54 outputs the high voltage on signal via the output port 541.

The gate of the NMOSFET Q4 of the switch unit 30 is electrically connected to the drain of the NMOSFET Q3 and receives the high voltage on signal, thus the NMOSFET Q4 is turned on accordingly. Therefore, there is a current flowing from the first coil terminal P1 to the second coil terminal P2 due to the NMOSFET Q4 being turned on. The normally closed end P3 is contacted with the normally open end P4 when the current flows from the first coil terminal P1 to the second coil terminal P2. Thus, the connection between the AC input port 10 and the AC output port 20 is established.

When the electronic device 200 is started up, and enters the operating system, the USB port 21 of the electronic device 200 output the high voltage. The voltage pin V+ of the USB port 40 receives the high voltage from the USB port 21 and outputs the high voltage. The diode D1 conducts the high voltage from the USB port 40 to the gate of the NMOSFET Q4 and maintains the NMOSFET Q4 to turn on.

In the embodiment, the variable resistor Rs, the delay resistor Rc, and the delay capacitor C1 constitute a RC delayer. The predetermined time delayed by the delay circuit 52 is determined by one of resistance values of the variable resistor Rs, the delay resistor Rc and a capacitance value of the delay capacitor C1. The predetermined time can be set as a short time, such as 10 seconds, by adjusting the values of the variable resistor Rs, the delay resistor Rc and the delay capacitor C1.

In the embodiment, the startup control unit 50 also includes a diode D2, the diode D2 is electrically connected between the drain of the NMOSFET Q3 and the gate of the NMOSFET Q4.

In the illustrated embodiment, the first follower 56 includes resistors R4, R5 and NMOSFETs Q5, Q6. The resistor R4 and the NMOSFET Q5 are connected between the voltage port Vcc and ground in series, and the resistor R5 and the NMOSFET Q6 also are connected between the voltage port Vcc and ground in series. A drain of the NMOSFET Q5 is connected to the voltage port Vcc via the resistor R4, a source of the NMOSFET Q5 is grounded, and a gate of the NMOSFET Q5 is connected to the drain of the NMOSFET Q2. The drain of the NMOSFET Q5 is also connected to a gate of the NMOSFET Q6. A drain of the NMOSFET Q6 is connected to the voltage port Vcc via the resistor R5, and a source of the NMOSFET Q6 is grounded. The drain of the NMOSFET Q6 is also connected to the capacitor C2.

The second follower 57 includes resistors R6, R7 and NMOSFETs Q7, Q8. The resistor R6 and the NMOSFET Q7 are connected between the voltage port Vcc and ground in series, and the resistor R7 and the NMOSFET Q8 are also connected between the voltage port Vcc and ground in series. A drain of the NMOSFET Q7 is connected to the voltage port Vcc via the resistor R6, a source of the NMOSFET Q7 is grounded, and a gate of the NMOSFET Q7 is connected to the drain of the NMOSFET Q3. The drain of the NMOSFET Q7 is also connected to a gate of the NMOSFET Q8. A drain of the NMOSFET Q8 is connected to the voltage port Vcc via the resistor R7, a source of the NMOSFET Q8 is grounded. The drain of the NMOSFET Q8 is also connected to the gate of the NMOSFET Q4 via the diode D2.

When the first signal generating circuit 53 produces the low voltage first signal via the output port 531, the gate of the NMOSFET Q5 receives the low voltage first signal and the NMOSFET Q5 is turned off accordingly. Therefore, the drain of the NMOSFET Q5 obtains the high voltage from the voltage port Vcc via the resistor R4, the gate of the NMOSFET Q6 is connected to the drain of the NMOSFET Q5 and receives the high voltage. Thus, the NMOSFET Q6 is turned on accordingly. The drain of the NMOSFET Q6 is grounded and at low voltage via the NMOSFET Q6 which is turned on. Therefore, the signal output to the capacitor C2 remains the low voltage first signal. If the first signal is a high voltage signal, the signal output to the capacitor C2 via the first follower 56 remains the high voltage signal.

When the second signal generating circuit 54 produces the high voltage on signal via the output port 541, the gate of the NMOSFET Q7 receives the high voltage first signal and the NMOSFET Q7 is turned on accordingly. Therefore, the drain of the NMOSFET Q7 is grounded and at low voltage via the NMOSFET Q7, which is turned on, and the gate of the NMOSFET Q8 is connected to the drain of the NMOSFET Q7 and receives the low voltage. Thus, the NMOSFET Q6 is turned off accordingly. The drain of the NMOSFET Q8 obtains the high voltage from the voltage port Vcc via the resistor R7. Therefore, the signal output to the NMOSFET Q4 of the switch unit 30 remains the high voltage on signal.

The first follower 56 receives the signal output by the first signal generating circuit 53 and then outputs the received signal, and the second follower 57 receives the signal output by the second signal generating circuit 53 and then outputs the received signal.

In the embodiment, the indication unit 70 includes a resistor R8 and at least one light emitting diode (LED) LD connected between the normally open end P4 and grounded in series. When the relay D is closed, namely the normally closed end P3 contacts with the normally open end P4, the LED LD is powered on and emits light to indicate the status of the electronic device 200 is now powered on.

In the embodiment, the electronic device 200 can be a tablet computer, a portable computer, a desktop computer, or a server.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A test device for testing a startup function of an electronic device, the test device comprising:
an alternating current (AC) input port configured to connect to an AC power source;
an AC output port configured to connect to a power port of the electronic device;
a switch unit connected between the AC input port and the AC output port, and configured to establish a connection between the AC input port and the AC output port, or cut off the connection between the AC input port and the AC output port;
a first universal serial bus (USB) port comprising a voltage pin, data pins, and a ground pin, wherein the first USB port is configured to connect to a second USB port of the electronic device and obtain a voltage from the second USB port when the electronic device is started up completely;
a startup control unit connected between the switch unit and the first USB port, and configured to turn on the switch unit after the electronic device is turned off for a predetermined time, so that the AC power source powers on the electronic device; and
a power on maintaining unit connected between the switch unit and the first USB port, and configured to maintain the switch unit to turn on when receiving the voltage from the first USB port after the electronic device has been started up completely.

2. The test device according to claim 1, wherein the startup control unit comprises a startup switch, a delay circuit, a first signal generating circuit, a capacitance unit, and a second signal generating circuit electrically connected between the voltage pin of the first USB port and the switch unit in series.

3. The test device according to claim 2, wherein when the electronic device is turned off, the startup switch is turned off, and the delay circuit measures a time elapsed when the startup switch is turned off and produces a trigger signal when the elapsed time reaches a predetermined time; the first signal generating circuit produces a first signal when receiving the trigger signal from the delay circuit, and the capacitance unit transmits the first signal from the first signal generating circuit to the second signal generating circuit; the second signal generating circuit outputs an on signal to the switch unit to turn on the switch unit when receiving the first signal.

4. The test device according to claim 3, wherein the startup control unit further comprises a first follower and a second follower, the first follower is connected between the first signal generating circuit and the capacitance unit, and is configured to transmit the first signal output by the first signal generating circuit to the capacitance unit; the second follower is connected between the second signal generating circuit and the switch unit, and is configured to transmit the on signal output by the second signal generating circuit to the switch unit.

5. The test device according to claim 2, wherein the startup switch comprises a first re-channel metal oxide semiconductor field effect transistor (NMOSFET) and a first resistor R1, a gate of the first NMOSFET is connected to the power pin of the first USB port, a source of the first NMOSFET is grounded via the first resistor, and a drain of the first NMOSFET is connected to the delay circuit.

6. The test device according to claim 5, wherein the delay circuit comprises a variable resistor, a delay resistor, and a delay capacitor; the variable resistor, the delay resistor, and the delay capacitor are connected between a voltage port and ground in series; a first connection node of the variable resistor and the delay resistor is connected to the drain of the first NMOSFET; a second connection node of the delay resistor and the delay capacitor is connected to the first signal generating circuit.

7. The test device according to claim 6, wherein the first signal generating circuit comprises a second resistor and a second NMOSFET connected between the voltage port and ground in series; a drain of the second NMOSFET is connected to the voltage port via the second resistor, a source of the second NMOSFET is grounded, a gate of the second NMOSFET is connected to the second connection node; the drain of the second NMOSFET constitutes an output port of the first signal generating circuit.

8. The test device according to claim 7, wherein the second signal generating circuit comprises a third resistor and a third NMOSFET connected between the voltage port and ground in series; a drain of the third NMOSFET is connected to the voltage port via the third resistor, a source of the third NMOSFET is grounded, and a gate of the third NMOSFET is connected to the capacitance unit; the drain of the third NOMSFET constitutes an output port of the second signal generating circuit.

9. The test device according to claim 2, wherein the switch unit comprises a relay and a fourth NMOSFET, the relay comprises a first coil terminal, a second coil terminal, a normally closed end, and a normally open end; the first coil terminal is connected to the voltage port, the second coil terminal is connected to a drain of the fourth NMOSFET, the normally closed end is connected to the AC input port, and the normally open end is connected to the AC output port; a gate of the fourth NMOSFET is electrically connected to the second signal generating circuit and receives the on signal from the second signal generating circuit, and a source of the fourth NMOSFET is grounded.

10. The test device according to claim 9, wherein the power on maintaining circuit comprises a diode, and the diode is forward biased between the voltage pin of the first USB port and the gate of the fourth NMOSFET.

11. The test device according to claim 7, wherein the first follower comprises a fourth resistor, a fifth resistor, a fifth NMOSFET, and a sixth NMOSFET; the fourth resistor and the fifth NMOSFET are connected between the voltage port and ground in series, the fifth resistor and the sixth NMOSFET are connected between the voltage port and ground in series; a drain of the fifth NMOSFET is connected to the voltage port via the fourth resistor, a source of the fifth NMOSFET is grounded, a gate of the fifth NMOSFET is connected to the drain of the second NMOSFET, and a drain of the fifth NMOSFET is connected to a gate of the sixth NMOSFET; a drain of the sixth NMOSFET is connected to the voltage port via the fifth resistor, a source of the sixth NMOSFET is grounded, and a drain of the sixth NMOSFET is connected to the capacitance unit.

12. The test device according to claim 8, wherein the second follower comprises a sixth resistor, a seventh resistor, a seventh NMOSFET, and an eighth NMOSFET; the sixth resistor and the seventh NMOSFET are connected between the voltage port and ground in series, and the seventh resistor and the eighth NMOSFET are connected between the voltage port and ground in series; a drain of the seventh NMOSFET is connected to the voltage port via the sixth resistor, a source of the seventh NMOSFET is grounded, and a gate of the seventh NMOSFET is connected to the drain of the third NMOSFET; the drain of the seventh NMOSFET is connected to a gate of the eighth NMOSFET; a drain of the seventh NMOSFET is connected to the voltage port via the seventh resistor, a source of the seventh NMOSFET is grounded, and a drain of the eighth NMOSFET is also connected to the switch unit.

13. The test device according to claim 1, further comprising an indication unit connected to the AC output port, wherein when the switch unit is turned on, the AC output port receives the voltage from the input port via the switch unit which is turned on, and provides the voltage to the indication unit; the indication unit produces a corresponding indication signal when receiving the voltage from the AC output port.

14. The test device according to claim 2, wherein the capacitance unit is a capacitor.

15. The test device according to claim 1, wherein the electronic device is a tablet computer, a portable computer, a desktop computer, or a server.
